(19) United States
(12) Patent Application Publication
(10) Pub. No.: US 2019/0368599 A1
(43) Pub. Date: Dec. 5, 2019

(54) SPORTS SHIFT KNOB WITH PUSH BUTTON TRANSMISSION

(71) Applicant: FORD GLOBAL TECHNOLOGIES, LLC, Dearborn, MI (US)

(72) Inventors: Alfonso Hickman Guevara, Tlalnepantla (MX); David Mercado, Coyoacan (MX); Luis Jesus Chavela Guerra, Mexico City (MX); Uriel Elam Loza, Tultitlan (MX); Diego Flores Fierros, Colinas del Lago (MX)

(21) Appl. No.: 15/997,169

(22) Filed: Jun. 4, 2018

(51) Int. Cl. F16H 59/02; B60K 20/02; F16H 59/12; F16H 59/04

(52) U.S. Cl. CPC F16H 59/0204; B60K 20/02; F16H 2059/0226; F16H 59/044; F16H 2059/0269; F16H 59/12

(57) ABSTRACT

An apparatus adapted to provide a push button transmission or a manual stick shift transmission experience, as selected by a motor vehicle operator, includes an electronic transmission selector, a foldable, electronic shift knob, displaceable between a stowed position and a deployed position, and a mechanical shift action module. The mechanical shift action module is connected to the foldable, electronic shift knob and provides the feel of a stick shift mechanically connected to the gearbox of the transmission of the motor vehicle.

### TECHNICAL FIELD

This document relates generally to the motor vehicle equipment field and, more particularly, to an apparatus having a sports shift knob and push button transmission that provide a unique and innovative sport/elegance driving experience.

### BACKGROUND

This document relates to a new and improved apparatus adapted to provide seemingly conflicting luxury push button transmission control and full manual transmission shift knob operation as desired at any particular moment by the motor vehicle operator. Thus, the apparatus allows the motor vehicle operator to experience the best of the luxury motor vehicle and sports car transmission experience.

### SUMMARY

In accordance with the purposes and benefits as described herein, a new and improved apparatus is provided for furnishing a motor vehicle operator with an elegant push button transmission or a sporty manual transmission shift knob experience at the desire of the motor vehicle operator. That apparatus comprises an electronic transmission selector, and a foldable, electronic shift knob. The electronic transmission selector allows one to operate the transmission in the simplest manner possible. In contrast, the foldable shift knob allows one to operate the transmission by means of a manual transmission experience. The foldable electronic shift knob is displaceable between a stowed position and a deployed position. A mechanical shift action module, connected to the foldable, electronic shift knob, provides the electronic shift knob with the feel of a mechanical linkage when used by the operator to shift the transmission electronically.

In one or more of the many possible embodiments of the apparatus, the electronic transmission selector includes a plurality of push buttons and a push button transmission electric module that allow one to select an operating mode of the transmission of a motor vehicle equipped with the apparatus by simply depressing a selected push button.

The electronic transmission selector may be provided at a first discrete location and the foldable electronic shift knob may be provided at a second discrete location within an interior of the motor vehicle. Thus, for example, the apparatus may include a console trim panel having a first receiver configure to receive the electronic transmission selector and a second receiver configured to receive the foldable electronic shift knob.

That foldable electronic shift knob may include a shank, a ball joint at a proximal end of the shank and a shift knob feature at a distal end of the shank. That shift knob feature may nest within a pocket of the second receiver when the foldable, electronic shift knob is displaced into the stowed position.

The plurality of push buttons of the electronic transmission selector may include a PARK mode push button, a REVERSE mode push button and a DRIVE mode push button. In one or more of the many possible embodiments of the apparatus, the plurality of push buttons may include a NEUTRAL mode push button. In one or more of the many possible embodiments of the apparatus, the plurality of push buttons may include a SPORT mode push button.

In one or more of the many possible embodiments, the apparatus may further include a human interface. That human interface may be configured to select operating parameters of the foldable, electronic shift knob when the foldable, electronic shift knob is in the deployed position. That human interface may comprise a touchscreen display such as a touchscreen display provided in the center stack of the motor vehicle, motor vehicle forward of the center console upon which the electronic transmission selector and the foldable, electronic shift knob are provided. In such an embodiment, the electronic transmission selector may be located between the foldable, electronic shift knob and a driver of the motor vehicle.

In one particularly useful embodiment of the apparatus, the mechanical shift action module connected to the foldable, electronic shift knob comprises a linear magnetic actuator—HD rumble—spherical—encoder module. Such a module is particularly adapted for providing a shift knob of an electronic shift-by-wire system with the feel of a mechanical linkage transmission.

In the following description, there are shown and described several preferred embodiments of the apparatus. As it should be realized, the apparatus is capable of other, different embodiments and their several details are capable of modification in various, obvious aspects all without departing from the apparatus as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the apparatus and together with the description serve to explain certain principles thereof.

FIG. 1a is a perspective view of the apparatus from above, illustrating the electronic transmission selector and the foldable, electronic shift knob located in separate receivers on a console trim panel of a motor vehicle wherein the foldable electronic shift knob is illustrated in the stowed position.

FIG. 1b is a view similar to FIG. 1a but illustrating the foldable, electronic shift knob in the deployed position wherein that shift knob stands upright ready for manipulation by the operator of the motor vehicle to shift the transmission of the motor vehicle.

FIG. 2 is a perspective view of the apparatus from below, illustrating the push button transmission electric module of the electronic transmission selector and the mechanical shift action module connected to the foldable, electronic shift knob.

FIG. 3 is a detailed side elevational view of the apparatus illustrating the foldable, electronic shift knob in the deployed position.

FIG. 4 is a detailed rear elevational view of the apparatus illustrating the foldable, electronic shift knob in the deployed position.

FIG. 5 is a schematic block diagram of the control system of the apparatus.

FIG. 6 is a control logic flow diagram illustrating the control logic for one possible embodiment of the apparatus illustrated in FIGS. 1a, 1b, 2, 3 and 4.

Reference will now be made in detail to the present preferred embodiments of the apparatus, examples of which are illustrated in the accompanying drawing figures.

### DETAILED DESCRIPTION

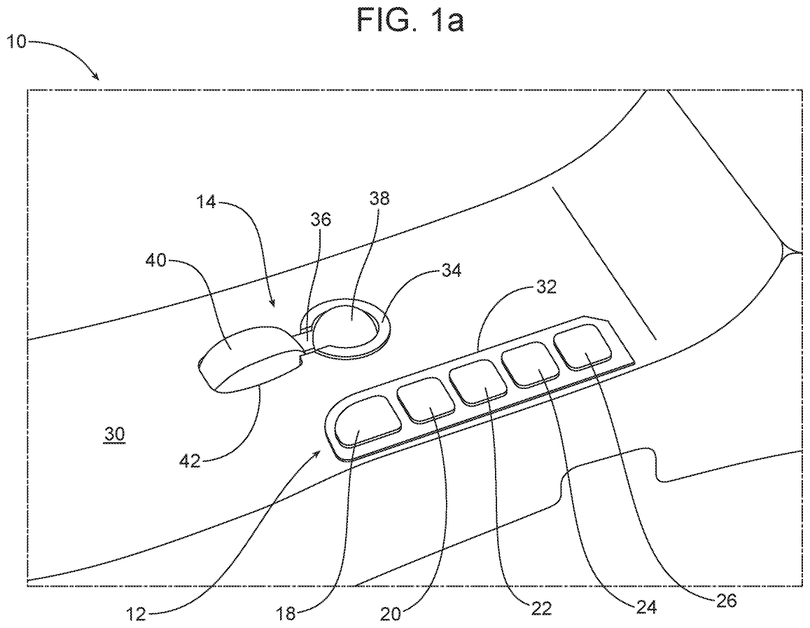

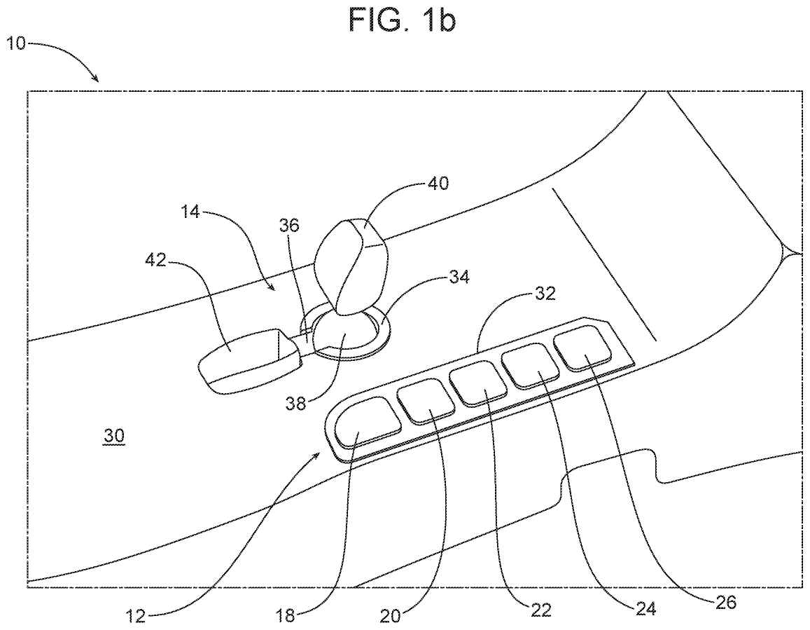

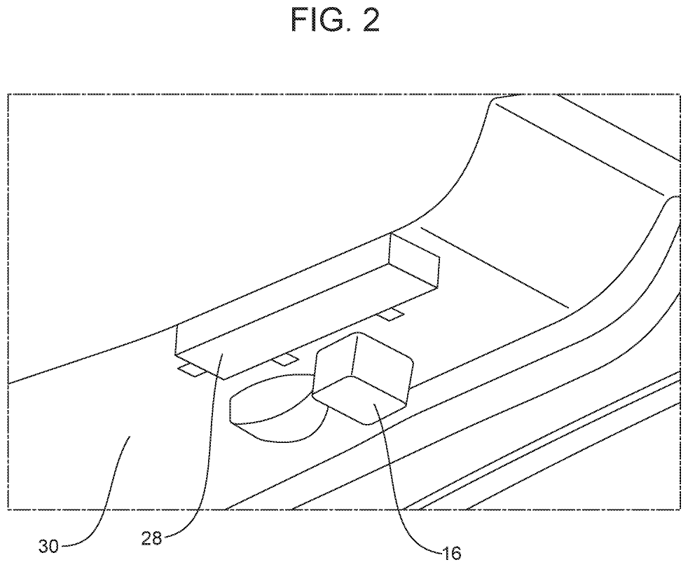

Reference is now made to FIGS. 1a, 1b, 2, 3 and 4 which illustrate the new and improved apparatus 10 adapted to provide both an elegant push button transmission and a sporty manual stick shift transmission experience in accordance with the desires of the motor vehicle operator. That apparatus 10 includes an electronic transmission selector 12, a foldable, electronic shift knob 14 and a mechanical shift action module 16.

In the illustrated embodiment, the electronic transmission selector 12 comprises a plurality of push buttons 18, 20, 22, 24, 26 connected to a push button transmission electric module 28. More particularly, in the illustrated embodiment, the plurality of push buttons include a PARK mode push button 18, a REVERSE mode push button 20, a NEUTRAL mode push button 22, a DRIVE mode push button 24 and a SPORT mode push button 26. Thus, an operator may depress any of the push buttons 18, 20, 22, 24, 26 to select the desired operating mode of the motor vehicle transmission. Thus, for example, the motor vehicle operator may place the transmission of the motor vehicle equipped with the apparatus 10 into park by depressing the PARK mode push button 18. When the PARK mode push button 18 is depressed, the connected push button transmission electronic module 28 sends an appropriate control signal to the transmission control module causing the transmission control module 54 to place the motor vehicle transmission into park.

Other operating modes of the transmission may be selected by pushing the other push buttons 20, 22, 24, 26. Thus, for example, DRIVE mode may be selected by depressing the DRIVE mode push button 24 while SPORT mode may be selected by depressing the SPORT mode push button 26.

As best illustrated in FIGS. 1a and 1b, the apparatus 10 may include a console trim panel 30. That console trim panel 30 may include a first receiver 32, configured to receive the electronic transmission selector 12, and a second receiver 34, configured to receive the foldable, electronic shift knob 14. In the illustrated embodiment, the first receiver 32 and second receiver 34 are provided at two discrete locations. Accordingly, the electronic transmission selector 12 may be provided at the first discrete location in the first receiver 32 while the foldable electronic shift knob 14 may be provided at the second discrete location at the second receiver 34. By providing the various push buttons 18, 20, 22, 24, 26 of the electronic transmission selector 12 at a conveniently accessed first discrete location remote from the foldable electronic shift knob 14 provided at an easily accessed second discrete location fully independent push button transmission controls and manual stick shift controls are provided for the convenience of the operator. This ensures that the operator does not inadvertently depress a push button when controlling the transmission of the motor vehicle with the foldable, electronic shift knob 14.

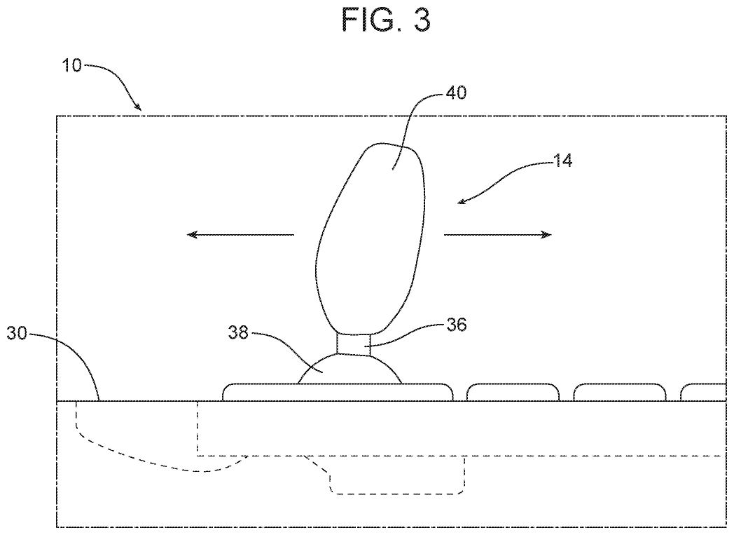

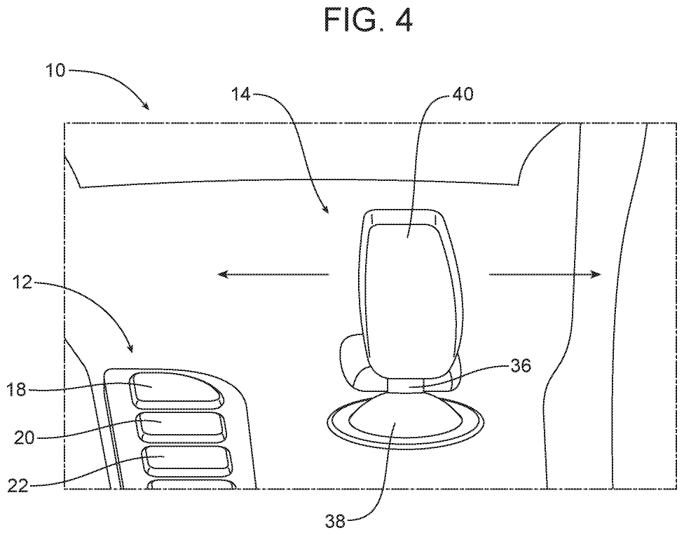

As illustrated in FIGS. 1a, 1b, 3 and 4, the foldable electronic shift knob 14 includes a shank 36, a ball joint 38 at a proximal end of the shank and a shift knob feature 40 at a distal end of the shank. The ball joint 38 provides the foldable electronic shift knob 14 with a full range of movement similar to a joy stick allowing for movement in a forward and backward direction of the shift knob feature 40 as illustrated in FIG. 3, a left to right direction as illustrated by the action arrows in FIG. 4 and anything in between.

In the illustrated embodiment, the foldable, electronic shift knob 14 is displaceable between a stowed position, illustrated in FIG. 1a and a deployed position illustrated in FIG. 1b. In the stowed position illustrated in FIG. 1a, the foldable, electronic shift knob 14 is folded flat so that the shift knob feature 40 nests within a pocket 42 of the second receiver 34 provided in the upper surface of the console trim panel 30. The apparatus 10 may be configured so that the foldable, electronic shift knob 14 is maintained in the stowed position whenever the transmission of the motor vehicle is being operated in the PARK mode, the REVERSE mode, the NEUTRAL mode and the DRIVE mode. When the foldable, electronic shift knob 14 is in the stowed position, a free, uninterrupted space is provided along the top of the console trim panel 30.

In contrast, when the transmission of the motor vehicle is operated in sport mode (such as by depressing the sport mode push button 26 twice), the foldable, electronic shift knob 14 is displaced into the deployed position illustrated in FIG. 1b. In this deployed position, the shift knob feature 40 projects upwardly from the console trim panel 30 where the motor vehicle operator may easily engage the shift knob feature with the hand and manipulate the foldable, electronic shift knob 14 in the manner necessary to manually shift the transmission of the motor vehicle between gears thereby effectively providing for a more sporty driving experience. As this is done, the mechanical shift action module 16 connected to the foldable, electronic shift knob 14 provides the feel of a mechanical transmission linkage. That mechanical shift action module 16 may comprise a linear magnetic actuator—HD rumble—spherical—encoder module of a type known in the art. Such a module is disclosed in, for example, US Patent Publication 2018-0028911. Also see WO2013134388 and WO2001024158. Of course, other modules or devices capable of providing the feel of a mechanical shift action transmission may be utilized.

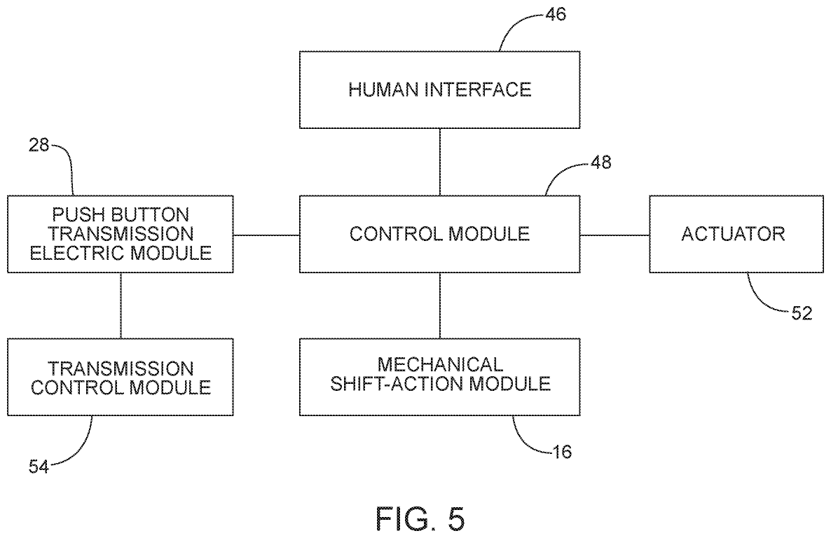

As illustrated in FIG. 5, the apparatus 10 may further include a human interface 46 configured to select operating parameters of the foldable, electronic shift knob 14 when in the deployed position. In the illustrated embodiment, that human interface comprises a touchscreen display of a type that may be provided in the center stack of the instrument panel of the motor vehicle forward of the console trim panel 30.

More particularly, the human interface 46 may provide the operator of the motor vehicle with a plurality of shift configuration options including various standard shift patterns of a type known in the art, a sequential shift pattern in the fore-and-aft direction as illustrated in FIG. 3, and a sequential shift pattern in the left-to-right lateral direction as illustrated in FIG. 4. Depending upon the selection made, the mechanical shift action module 16 may be configured to provide the feel of a gated manual transmission of various different configurations.

Toward this end, it should be appreciated that the apparatus 10 may incorporate a main control module 48 connected to the human interface 46 and adapted or configured to control the mechanical shift action module 16 and provide the desired mechanical linkage experience to the operator when shifting the foldable, electronic shift knob 14 between gears. Such a control module 48 may comprise a computing device such as a dedicated microprocessor or electronic control unit (ECU) operating in accordance with instructions from appropriate control software. Thus, the control module 48 may comprise one or more processors, one or more memories and one or more network interfaces all in communication with each other over one or more communication buses.

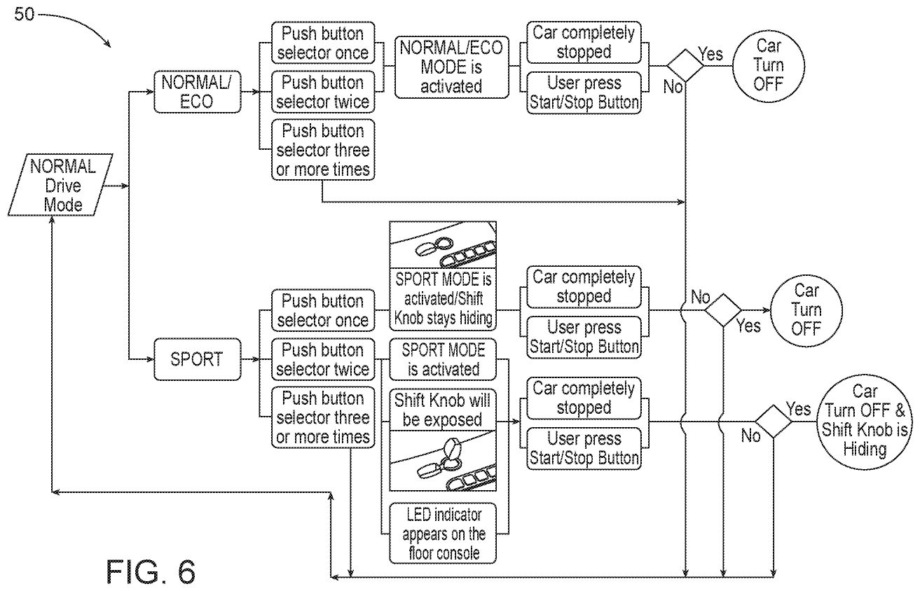

FIG. 6 illustrates one possible embodiment of control logic flow diagram 50 for the apparatus 10. That control logic flow diagram 50 is self-explanatory. When the transmission of the motor vehicle is in normal or eco operating mode by selecting PARK, REVERSE, NEUTRAL OR DRIVE via the push buttons 18, 20, 22, 24, the foldable, electronic shift knob 14 is maintained in the stowed position illustrated in FIG. 1a with the shift knob feature 40 nested within the pocket 42 of the second receiver 34 in the console trim panel 30.

When the sport mode push button 26 has been depressed once, the transmission is operated in sport mode with the foldable, electronic shift knob 14 maintained in the stowed position. In contrast, when the sport mode push button 26 is depressed twice, full sport mode is activated and the foldable, electronic shift knob 14 is displaced into the deployed position illustrated in FIG. 1b where it may be engaged by the motor vehicle operator and manipulated to shift the transmission of the motor vehicle.

When the sport mode push button 26 is depressed three or more times, the apparatus 10 returns to normal/eco operating mold and the foldable, electronic shift knob 14 is displaced back into the stowed position illustrated in FIG. 1a. Here it should be noted that an actuator 52 connected to the foldable, electronic shift knob 14 and controlled by the control module 48 may function to displace the foldable, electronic shift knob 14 between the stowed position and the deployed position. That actuator 52 does not interfere with the mechanical shift-action module 16 that mimics or replicates the feel of a manual transmission having a shift knob feature 40 mechanically linked to the gearbox of the transmission.

The foregoing has been presented for purposes of illustration and description. It is not intended to be exhaustive or to limit the embodiments to the precise form disclosed. Obvious modifications and variations are possible in light of the above teachings. For example, the electronic transmission selector 12 of the illustrated embodiment is a push button selector. In alternative embodiments, the electronic transmission selector 12 may comprise a dial selector or other appropriate means of selecting the operating mode of the transmission of the motor vehicle. All such modifications and variations are within the scope of the appended claims when interpreted in accordance with the breadth to which they are fairly, legally and equitably entitled.

What is claimed:

1. An apparatus, comprising:
an electronic transmission selector;
a foldable electronic shift knob displaceable between a stowed position and deployed position; and
a mechanical shift action module connected to said foldable, electronic shift knob.

2. The apparatus of claim 1, wherein said electronic transmission selector includes a plurality of push buttons and a push button transmission electric module.

3. The apparatus of claim 2, wherein said mechanical shift action module is a linear magnetic actuator-HD rumble-spherical-encoder module.

4. The apparatus of claim 3, wherein said electronic transmission selector is provided at a first discrete location and said foldable electronic shift knob is provided at a second discrete location within an interior of a motor vehicle.

5. The apparatus of claim 4, further including a console trim panel having a first receiver configured to receive said electronic transmission selector and a second receiver configured to receive said foldable, electronic shift knob.

6. The apparatus of claim 5, wherein said foldable, electronic shift knob includes a shank, a ball joint at a proximal end of said shank and a shift knob feature at a distal end of said shank.

7. The apparatus of claim 6, wherein said shift knob feature nests in a pocket of said second receiver when in said stowed position.

8. The apparatus of claim 7, wherein said plurality of push buttons include a PARK mode push button, a REVERSE mode push button and a DRIVE mode push button.

9. The apparatus of claim 8, wherein said plurality of push buttons include a NEUTRAL mode push button.

10. The apparatus of claim 9, wherein said plurality of push buttons include a SPORT mode push button.

11. The apparatus of claim 10, further including a human interface configured to select operating parameters of said foldable, electronic shift knob.

12. The apparatus of claim 11, wherein said human interface is a touch screen display.

13. The apparatus of claim 12, wherein said electronic transmission selector is located between said foldable, electronic shift knob and a driver of said motor vehicle.

14. The apparatus of claim 1, wherein said electronic transmission selector is provided at a first discrete location and said foldable electronic shift knob is provided at a second discrete location within an interior of a motor vehicle.

15. The apparatus of claim 14, further including a console trim panel having a first receiver configured to receive said electronic transmission selector and a second receiver configured to receive said foldable, electronic shift knob.

16. The apparatus of claim 15, wherein said foldable, electronic shift knob includes a shank, a ball joint at a proximal end of said shank and a shift knob feature at a distal end of said shank.

17. The apparatus of claim 16, wherein said shift knob feature nests in a pocket of said second receiver when in said stowed position.

18. The apparatus of claim 17, further including a human interface configured to select operating parameters of said foldable, electronic shift knob.

19. The apparatus of claim 18, wherein said human interface is a touch screen display.

20. The apparatus of claim 19, wherein said electronic transmission selector is located between said foldable, electronic shift knob and a driver of said motor vehicle.
